(19) United States
(12) Patent Application Publication
(10) Pub. No.: US 2013/0010463 A1
(43) Pub. Date: Jan. 10, 2013

(54) ILLUMINATION DEVICE

(75) Inventors: Chao-Wei Li, Hsinchu City (TW); Cheng-Da Shaw, Taipei City (TW); Hung-Lieh Hu, Hsinchu City (TW); Yi-Jen Chan, Taoyuan County (TW)

(73) Assignee: INDUSTRIAL TECHNOLOGY RESEARCH INSTITUTE, Hsinchu (TW)

(21) Appl. No.: 13/410,306

(22) Filed: Mar. 2, 2012

Related U.S. Application Data
(60) Provisional application No. 61/504,328, filed on Jul. 5, 2011.
(60) Provisional application No. 61/557,352, filed on Nov. 8, 2011.

(51) Int. Cl. F21V 29/00; F21V 21/00; F21V 11/00

(52) U.S. Cl. 362/235; 362/249.01; 362/249.02

(57) ABSTRACT

An illumination device including a base, a heat dissipation member, an FPC board and a plurality of light-emitting elements is provided. The heat dissipation member is disposed on the base. The heat dissipation member has a center axis and a curved surface. The center axis passes through the base and the curved surface surrounds the center axis. The FPC board is disposed on the curved surface. The light-emitting elements are disposed on the FPC board.

### CROSS-REFERENCE TO RELATED APPLICATION

This application claims the priority benefit of U.S.A. provisional application Ser. No. 61/504,328, filed on Jul. 5, 2011, and application Ser. No. 61/557,352, filed on Nov. 8, 2011. The entirety of each of the above-mentioned patent applications is hereby incorporated by reference herein and made a part of this specification.

### TECHNICAL FIELD

The technical field relates to an illumination device. More particularly, the technical field relates to an LED illumination device.

### BACKGROUND

A light-emitting diode (LED) is a semiconductor element, and the material for forming a light-emitting chip using the LED mainly includes group III-V chemical compounds\, such as gallium phosphide (GaP), gallium arsenide (GaAs), and other compound semiconductors. Using the light-emitting principle of the semiconductor PN junction, electric energy is converted into light. The life span of the LED may be more than 100,000 hours, and the LED has the advantage of high response speed, small volume, little electricity consumption, low pollution (no mercury), great reliability and also easy adaptation for mass production.

Because of the need to save power and protect the environment, using the LED in illumination devices to provide light has become the trend worldwide. The current technique is for the LED to be disposed as a light emitting element on a carrier, for example a printed circuit board.

The LED also generates great heat when producing light, and in the illumination devices described above, the heat generated by the LED can not be effectively dissipated to external surroundings, thus deteriorating device performance. Taking the LED bulb for an example, in order to avoid overheating, a heat dissipation structure is disposed on the LED bulb. If the heat dissipation efficiency of the LED bulb is poor, the durability of the LED bulb is also decreased. Furthermore, due to these limitations of the light-emitting mode of the LED, current LED bulbs can not reach the illumination range of incandescent bulbs or spiral power-saving bulbs. Therefore, how to improve the illumination range, the heat dissipation efficiency and the durability of LED bulbs has become an important issue.

### SUMMARY

The present embodiment provides an illumination device including a base, a heat dissipation member, at least one flexible printed circuit (FPC) board and a plurality of light-emitting elements. The heat dissipation member is disposed on the base. The heat dissipation member has a center axis and at least one curved surface. The center axis passes through the base and the curved surface surrounds the center axis. The FPC board is disposed on the curved surface. The light-emitting elements are disposed on the FPC board.

### BRIEF DESCRIPTION OF THE DRAWINGS

FIG. 1 is a schematic view of an illumination device according to an embodiment.

FIG. 2 is a partial exploded view of an illumination device according to an embodiment.

FIG. 3 is a schematic view of an illumination device according to another embodiment.

FIG. 4 and FIG. 5 are partial exploded views of two illumination devices according to another two embodiments.

Common reference numerals are used throughout the drawings and the detailed description to indicate the same elements. The present invention will be more apparent from the following detailed description taken in conjunction with the accompanying drawings.

### DETAILED DESCRIPTION

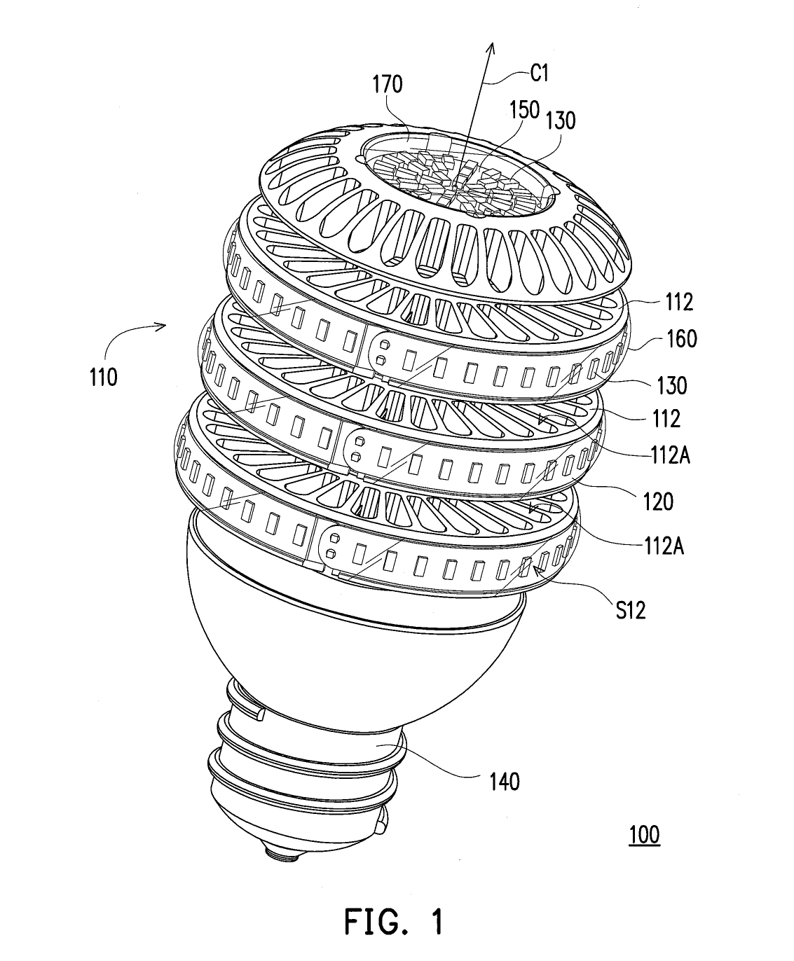

FIG. 1 is a schematic view of an illumination device according to an embodiment. Referring to FIG. 1, an illumination device 100 includes a heat dissipation member 110, a plurality of flexible printed circuit (FPC) boards 120, a plurality of light-emitting elements 130, a base 140, a top circuit board 150 and a plurality of optical elements 160. The heat dissipation member 110 can be, for example, made of heat conducting plastic by an injection molding technique or made of metal with high heat conductibility. The heat dissipation member 110 has a center axis C1 and a plurality of curved surfaces S12. The center axis C1 passes through the base 140. The curved surfaces S12 surround the center axis C1. Each FPC board 120 is disposed on a curved surface S12. There are a plurality of light-emitting elements 130 disposed on each FPC board and each FPC board 120 is covered by an optical element 160. Three FPC boards are illustrated in the present embodiment, however each illumination device 100 also can have more or less than three FPC boards 120. The number of the FPC boards 120, the corresponding curved surfaces S12 and the optical elements 160 can be adjusted according to actual demand. Moreover, the sizes and the shapes of the FPC boards 120, the corresponding curved surfaces S12 and the optical elements 160 can also be different based on actual demand.

Based on the above, the light-emitting elements 130 can surround the surface profile of the heat dissipation member 110 by adopting the flexibility of the FPC boards 120 so as to emit the light in various directions. Furthermore, with the design of the FPC board 120 disposed on the surface of the heat dissipation member 110, the heat generated by the light-emitting elements 130 during operation can be dissipated rapidly, so as to improve the light-emitting efficiency and also extend the life span of the illumination device 100. Moreover, the illumination device 100 of the present embodiment has a light-emitting mode similar to the conventional spiral power-saving bulb without the flaws such as mercury pollution and the brittleness of the glass.

The light-emitting elements 130 of the present embodiment are, for example, the LEDs packaged on the FPC boards 120, wherein the LEDs are disposed on the FPC boards 120 by surface mount technology (SMT) or a chip on board (COB) process. The present embodiment does not limit the packaging method of the light-emitting elements 130. In other not shown embodiments, the optical lens can be disposed on each light-emitting element 130 so as to adjust the light-emitting angle of the light-emitting elements 130 to an ideal range. The optical elements 160 of the present embodiment are optional components which respectively cover the light-emitting elements 130 of the each FPC board 120. The optical elements 160 not only can be protection structures for the FPC boards 120 and the light-emitting elements 130, but also can change the wavelength of the light-emitting elements 130 or enhance the light scattering effect of the illumination device 100 by adding fluorescent powders or diffusion particles therein. The top circuit board 150 of the present embodiment is also an optional component disposed on the top of the heat dissipation member 110 away from the base 140. The center axis C1 passes through the center of the top circuit board 150 and the light-emitting elements 130 are also disposed on the top circuit board 150. The light-emitting elements 130 of the top circuit board 150 enhance the light-emitting brightness of the illumination device 100 in the upward direction. The light-emitting elements 130 of the top circuit board 150 can be covered by a top optical element 170. The function of the top optical element 170 is substantially the same as the optical element 160 but the profile of the top optical element 170 can be different from the profile of the optical element 160 in order to match the profile of the top circuit board 150.

The heat dissipation member 110 of the present embodiment is formed in one piece, but the heat dissipation member 110 can be divided into a plurality of disc portions 112. The center axis C1 passes through each of the centers of the disc portions 112 and is perpendicular to the disc portions 112. The outer edge of the disc portions 112 is the curved surface S12 described above and the curved surface S12 can be parallel to the center axis C1, and also can be an inclined surface according to actual requirements (not shown), such that the light emitted from the light-emitting elements 130 can propagate toward the inclined angles of the inclined surfaces. Each disc portion 112 has a plurality of through holes 112A. The through holes 112A are spread outward from the center of each disc portion 112. The through holes 112A disposed on the heat dissipation member 110 not only reduce the weight of the heat dissipation member 110 but also enhance the strength of the structure, and further increase the heat dissipation area of the heat dissipation member 110, such that the heat generated by the light-emitting elements 130 can be dissipated rapidly. The center parts of the disc portions are connected and the remaining parts of the disc portions are parallel to and keep a distance from each other. The distance between the disc portions 112 provides for circulation of the air so as to improve the heat dissipation efficiency.

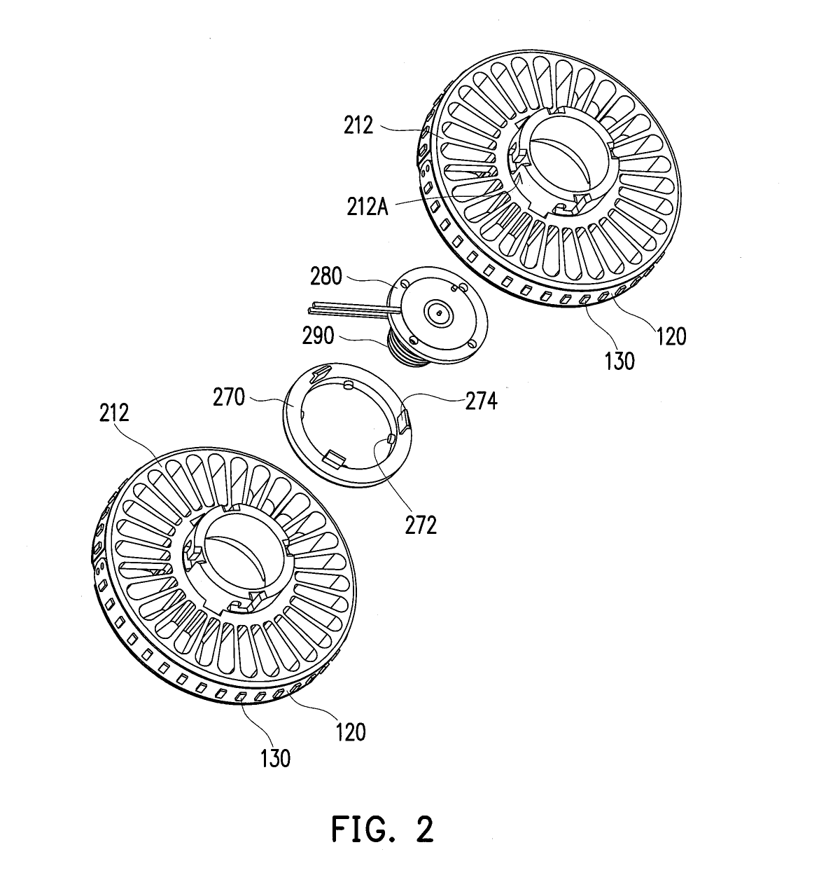

FIG. 2 is a partial exploded view of an illumination device according to an embodiment. Referring to FIG. 2, the illumination device of the present embodiment is similar to the illumination device 100 of FIG. 1, the difference is that each disc portion 212 of the present embodiment is an independent component and all can be connected to each other to form a heat dissipation structure similar to the heat dissipation structure 110 of FIG. 1. One of the sides of each disc portion 212 has a plurality of J-shaped positioning grooves 212A. An inner edge of a positioning ring 270 has a plurality of positioning pins 272. The positioning pins 272 are suitable for respectively sliding into the entrance of the J-shaped positioning grooves 212A. Next, the positioning pins 272 are rotated relative to the disc portion 212 such that the positioning pins 272 respectively slide through the center part of the J-shaped positioning grooves 212A. Finally, the positioning ring 270 is pulled away from the disc portion 212 such that the positioning pins 272 are respectively positioned at the end part of the J-shaped positioning grooves 212A so as to prevent the positioning pins 272 from rotating relative to the disc portions 212 again. The positioning ring 272 has a plurality of hooks 274 configured to latch into the center of another disc portion 212. Thus, the assembling of the two disc portions 212 is completed. However, the hooks 274 and the positioning pins 272 provided by the positioning ring 270 can also be disposed directly on the disc portions 212. The present embodiment is not limited to assembling the two disc portions 212 with the positioning ring 270.

In addition, a circuit board 280 can be disposed on the center of the disc portion 212 so as to electronically connect to the FPC boards 120 outside of the disc portion 212. A spring 290 can be disposed between the two adjacent FPC boards 120 to keep the positioning pins 272 at the end part of the J-shaped positioning grooves 212A and not moving back to the center part of the J-shaped positioning grooves 212A, such that the stability of the assembly can be secured. With the modular design, the number of the disc portions 212 and the number of the light-emitting elements 130 of the illumination device of the present embodiment can be easily changed so as to adjust the brightness of the illumination device.

Moreover, the light-emitting elements 130 in different positions can be lit up selectively by controlling the circuit so as to control the distribution of the brightness. Alternatively, light-emitting elements 130 that provide light with various wavelengths can be disposed on the illumination device so as to provide warm color white light, cold color white light, red light, green light, blue light or other mixed color light.

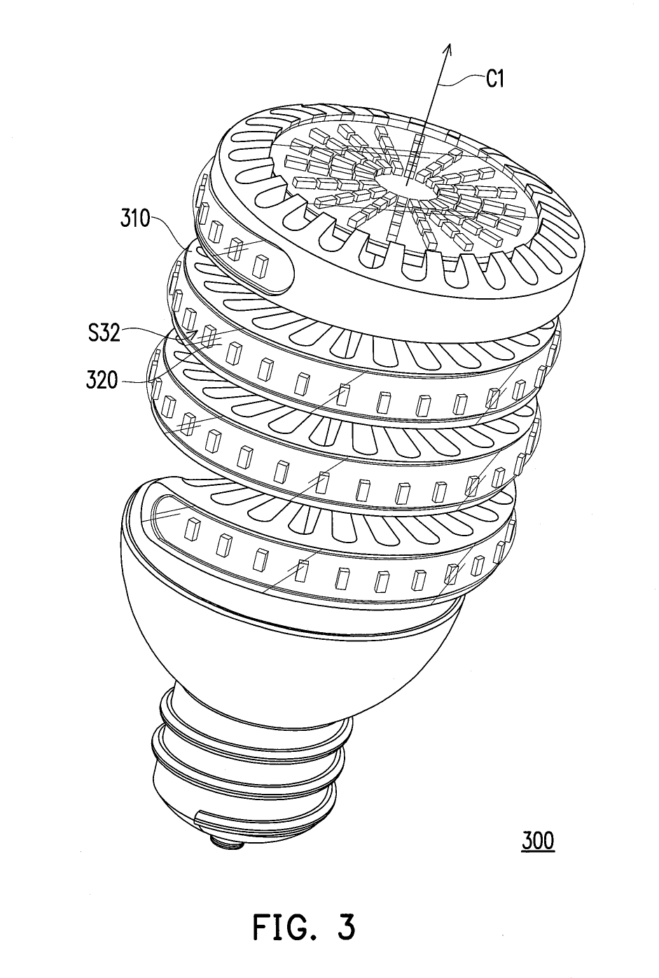

FIG. 3 is a schematic view of an illumination device according to another embodiment. Referring to FIG. 3, the difference between the present embodiment and the embodiment described above is that the curved surface S32 of the heat dissipation member 310 of the illuminating device 300 is in a stripe shape and spirals around the center axis C1 for a plurality of turns. The FPC boards 320 disposed on the curved surface S32 also spiral around the center axis C1 for a plurality of turns. The light-emitting mode of the illumination device 300 of the present embodiment is closer to the light-emitting mode of the conventional spiral power-saving bulb.

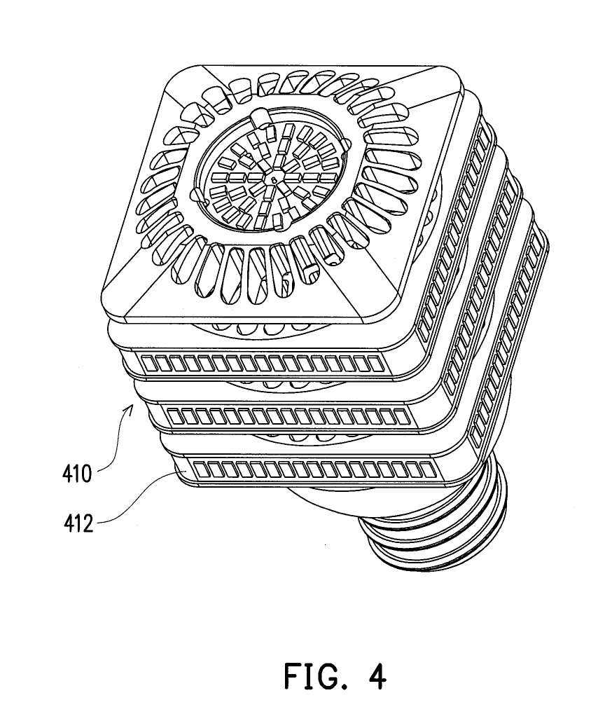

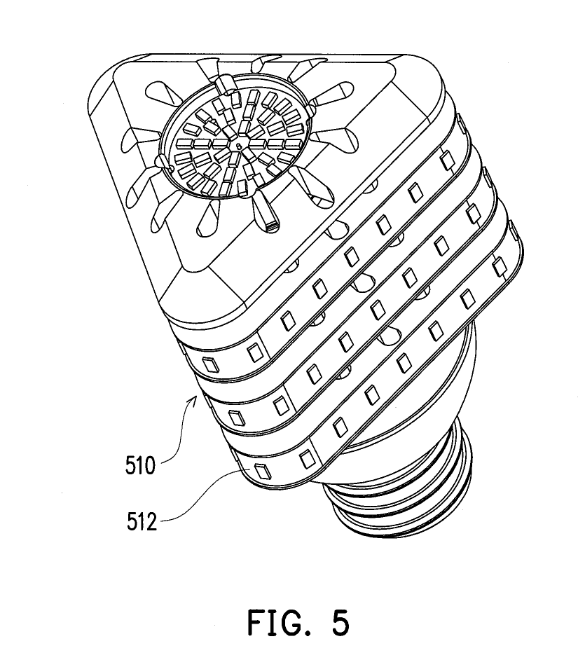

FIG. 4 and FIG. 5 are partially exploded views of two illumination devices according to another two embodiments. Referring to FIG. 4 and FIG. 5, the illumination devices of the present two embodiments are similar to the illumination device 100 in FIG. 1 in both function and structure, but the heat dissipation member 410 in FIG. 4 is, viewed from the exterior, divided into a plurality of square disc portions 412 and the heat dissipation member 510 in FIG. 5 is, viewed from the exterior, divided into a plurality of triangular disc portions 512. The heat dissipation members of the illumination devices in the present embodiment can also be divided into single or a plurality of portions in other geometric shapes.

To sum up, the FPC boards and the light-emitting elements disposed thereon can surround the surface profile of the heat dissipation member by adopting the flexibility of the FPC boards. Also, with different arrangements of the light-emitting elements on the FPC boards, the illumination device adopting the LED as the light source can be similar to the conventional spiral power-saving bulb in light-emitting mode, so as to improve the lighting range of the illumination device. Moreover, the light-emitting elements are disposed on the heat dissipation member, so the heat generated by the light-emitting elements can be dissipated rapidly, enhancing the heat dissipation efficiency.

While the invention has been described and illustrated with reference to specific embodiments thereof, these descriptions and illustrations do not limit the invention. It should be understood by those skilled in the art that various changes may be made and equivalents may be substituted without departing from the true spirit and scope of the invention as defined by the appended claims. The illustrations may not necessarily be drawn to scale. There may be distinctions between the artistic renditions in the present disclosure and the actual apparatus due to manufacturing processes and tolerances. There may be other embodiments of the present invention which are not specifically illustrated. The specification and the drawings are to be regarded as illustrative rather than restrictive. Modifications may be made to adapt a particular situation, material, composition of matter, method, or process to the objective, spirit and scope of the invention. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. An illumination device, comprising:
a base;
a heat dissipation member, disposed on the base, wherein the heat dissipation member has a center axis and at least one curved surface, the center axis passes through the base, and the at least one curved surface surrounds the center axis;
at least one flexible printed circuit (FPC) board, disposed on the at least one curved surface; and
a plurality of light-emitting elements, disposed on the at least one FPC board.

2. The illumination device as claimed in claim 1, wherein the heat dissipation member includes a plurality of disc portions, the center axis passes through the center of the disc portions and is perpendicular to the disc portions, the numbers of the at least one FPC board and the at least one curved surface are more than one, and the curved surfaces are located on outer edges of the disc portions.

3. The illumination device as claimed in claim 2, wherein each disc portion has a plurality of through holes spread outward from the center of each disc portion.

4. The illumination device as claimed in claim 2, wherein the center parts of the disc portions are connected, and the remaining parts of the disc portions are parallel to and keep a distance from each other.

5. The illumination device as claimed in claim 2, wherein the disc portions are independent from each other and suitable for being connected to each other.

6. The illumination device as claimed in claim 5, further comprising at least one positioning ring for connecting two disc portions.

7. The illumination device as claimed in claim 2, wherein each disc portion is a part of the heat dissipation member formed in one piece.

8. The illumination device as claimed in claim 1, further comprising an optical element, covering the light-emitting elements.

9. The illumination device as claimed in claim 8, wherein the optical element includes fluorescent powders or diffusion particles.

10. The illumination device as claimed in claim 1, wherein the light-emitting elements are light-emitting diodes (LEDs).

11. The illumination device as claimed in claim 1, wherein the at least one curved surface is in a stripe shape and spirals around the center axis for a plurality of turns.

12. The illumination device as claimed in claim 1, further comprising a top circuit board, disposed on the top of the heat dissipation member, wherein the top of the heat dissipation member is away from the base, the center axis passes through the center of the top circuit board, and part of the light-emitting elements are disposed on the top circuit board.
